(19) United States
(12) Patent Application Publication
(10) Pub. No.: US 2014/0285337 A1
(43) Pub. Date: Sep. 25, 2014

(54) Automobile Alert System for Recording and Communicating Incidents to Remote Monitoring Devices

(71) Applicant: Mark Anthony Gebhardt, Magnolia, MS (US)

(72) Inventor: Mark Anthony Gebhardt, Magnolia, MS (US)

(21) Appl. No.: 14/221,571

(22) Filed: Mar. 21, 2014

Related U.S. Application Data
(60) Provisional application No. 61/804,090, filed on Mar. 21, 2013.

(51) Int. Cl. G08B 19/00

(52) U.S. Cl. CPC G08B 19/00
USPC 340/521

(57) ABSTRACT

Provided is a system and method for affecting remote control of a vehicle incident reporting system. The system has a remote server, one or more client mobile devices, a subsystem of recording devices and sensor units forming a detecting and recording system, and a network via which the component elements communicate. The system is deployed within a vehicle, either at the time of manufacture or as after market upgrades. The detection and recording system perceives threats to the vehicle and initiates recording of multimedia recording devices. Captured data is then sent to the remote server. Transmissions are retained on a storage media associated with the server. Database entries for a user account linked to the vehicle are updated to include incident information and the received data communications. The server also transmits a notification to a mobile device linked to the user account, to inform the user about the incident.

### CROSS REFERENCE TO RELATED APPLICATION

This application claims the benefit of U.S. Provisional Application No. 61/804,090 filed on Mar. 21, 2013, entitled “Anywhere Auto Secure.” The above identified patent application is herein incorporated by reference in its entirety to provide continuity of disclosure.

### BACKGROUND OF THE INVENTION

1. Field of the Invention

The present invention relates to systems and methods for detecting incidents, recording data related thereto, and transmitting captured data to remove servers and mobile devices. More specifically, the present invention relates to initiation of audio visual recording, alert transmission, and streaming of captured data to a remote device synchronized with the data capture system via one or more remote servers. The data capture system, servers, and mobile devices are paired to a user account thereby ensuring that data streaming is enabled for only the owner-user of the data capture system.

As the use of mobile computing devices continues to grow, a wide assortment of mobile applications for remote control of base station devices has become available. Such base station devices may include smart home monitoring systems, television recording devices, personal computers running file transfer applications and any other device capable of data transfer via cloud-based computing. These systems and devices may be remotely monitored and controlled by service providers, but demand for user control from remote locations is steadily increasing.

In the automotive sector, companies such as OnStar™ and Lojack™ monitor an automobile's electrical system integrity for intrusions and damage. Collisions are immediately detected and transmitted to the service provider. The service provider then calls the vehicle owner to inform the owner of the incident. Some detection system models offer in-vehicle displays that facilitate streaming audio video communication between the owner-user and a service provider representative. Live chat with a service provider can soothe anxious owners and ensure that emergency safety procedures are followed.

The primary drawback to these automotive monitoring systems is that they do not offer user control over the monitoring system. To the contrary, only the service provider has access to the installed intrusion detection and monitoring system. Owners are notified after an incident is detected, but are not provided access to the data collected regarding the incident. This can leave vehicle owners feeling out of touch with the vehicle and frustrated at their lack of knowledge about an incident.

An automobile incident detection and reporting system is needed that provides owners with direct access to data gathered by the system. The present invention provides users with real-time feedback received from the incident detection system and places the decision of how to react to an incident within the control of the owner-user.

2. Description of the Prior Art

Devices have been disclosed in the prior art that relate to automobile protection systems. These include devices that have been patented and published in patent application publications. These devices generally relate to systems for detecting intrusions or collisions. The following is a list of devices deemed most relevant to the present disclosure, which are herein described for the purposes of highlighting and differentiating the unique aspects of the present invention, and further highlighting the drawbacks existing in the prior art.

Seamann et al, U.S. Pat. No. 6,211,907, discloses a data capture system mounted on a vehicle. The system monitors a vehicle's electrical system status, detects intrusions, and captures information about incidents. Audio and video recording devices are mounted to the vehicle to affect data capture. The captured data is stored in files that are subsequently encrypted. Files may be transmitted off site to local authorities or stored on servers. For evidentiary purposes, the encrypted files may be downloaded and decrypted using a password or other means of authentication. Unlike the present invention, the Seamann system does not provide the user with access to the data captured by the system, in real time.

Another data capture system is disclosed in Back, U.S. Pat. No. 6,676,308. This system includes a camera mounted to the exterior of an automobile for recording photos of a traffic collision. The shutter of the camera is triggered by inertial changes such as those occurring when two cars collide. Upon activation, the camera takes pictures of the collision. These photos can later be removed from the camera storage and used for evidentiary purposes. A similar system is disclosed by Kurylo, U.S. Patent Application Publication No. 2008/0239077. The Kurylo system operates in a similar fashion to the Back system, but includes a video camera rather than a still frame camera. Video recording is triggered by changes in the vehicle's inertia, and upon impact with another object. Back and Kurylo do not disclose remote storage of the captured data, nor do they disclose remote synchronization with mobile devices.

A monitoring system allowing user access is provided by Plante, U.S. Patent Application Publication No. 2007/0219685. This system has a variety of recording devices such as audio and video recorders disposed about the vehicle and a storage media associated therewith. Captured data is stored on the storage media for later transmission. When the vehicle returns to a home location, it connects with a local area network and data stored on the storage media is transferred to an in-home computer. The data can then be viewed via a web portal. Users can manipulate and analyze the data, and elect to save it for later use or delete it. Unlike the present invention, Plante's system does not provide users with real-time remote control and monitoring of a vehicle monitoring system.

Bezborodko, U.S. Patent Application Publication No. 2010/0271480 discloses a hidden camera recording system for automobiles. One or more video cameras are concealed within the vehicle such that their lenses are directed outward and are capable of recording the area proximate to the vehicle. A sensory unit that detects the presence of objects near the vehicle and the occurrence of an impact initiates video capture. Mirrors may be used to reflect images to the video cameras in the event that certain portions of the vehicle environment are difficult to film.

These prior art devices have several known drawbacks. The devices in the prior art do not offer real-time review of data captured by the incident recording system. Nor do these systems provide a user with remote control over the incident recording system. The present invention addresses these problems by enabling users to watch streamed live recordings of data captured by the incident recording system with only a minimal time delay for transmission. In light of the devices disclosed in the prior art, it is submitted that the present invention substantially diverges in design elements from the prior art and consequently it is clear that there is a need in the art for an improvement to existing vehicle monitoring systems. In this regard the instant invention substantially fulfills these needs.

### SUMMARY OF THE INVENTION

In view of the foregoing disadvantages inherent in the known types of incident reporting systems now present in the prior art, the present invention provides a new live data streaming to remote client devices wherein the same can be utilized for providing convenience for the user when determining how to react to an incident.

The present invention includes systems and techniques for affecting remote control of a vehicle incident reporting system and transmission of data as it is captured by the same. The system will include a server with a network connection, one or more mobile devices configured to communicate over a network, a subsystem of recording devices and sensor units forming a detecting and recording system, and a network. Incident recording systems are deployed within individual vehicles, either at the time of manufacture or as after market upgrades. At the time of installation, a vehicle identifier is entered into a memory associated with the incident reporting system. Similarly, a credential is created that includes the vehicle identifier. The credential is used to authenticate communications from the incident reporting system to the remote server. Authenticated communications are retained on a storage media associated with the server. Database entries for a user account linked to the credential and vehicle identifier are updated to include incident information and the received data communications. The server also transmits a notification to a mobile device linked to the user account, thereby alerting the user to the nature of a recorded incident.

An application layer protocol (hereinafter the application) stored on a storage of the mobile device and operable to receive the transmissions from the remote server via a network. The application can initiate audio, visual, or tactile feedback via the mobile device's display, speakers, and vibration mechanism. Feedback is intended to catch the user's attention in the same manner as receiving an incoming call or text message. In some embodiments, the application may initiate a unique feedback pattern to inform the user that the feedback is associated with a vehicle incident and immediate attention is required.

A key aspect of the present invention is the user's ability to playback captured data on demand. The function is accessed through the application. Users can select to view playback after an incident occurs, or may choose to begin recording at a time of their choosing and watch data playback as the mobile device receives it. In this manner, users can immediately view data captured in response to an incident, and may also check in on their vehicle at any time throughout their absence from the vehicle. The system provides users with information useful in making incident response decisions. The system further provides users with peace of mind when they need to leave their vehicle for a prolonged period of time, or when they must leave it in a less than ideal environment.

An additional function enables users to alert authorities local to the vehicle and transmit captured data to same. Users are thus able to determine whether or not the police should be notified regarding a particular incident. Proper deployment of the present system will reduce the number of false alarms received by police from computerized security systems, because the system allows a user to review incident alerts before passing them on to the police.

It is therefore an object of the present invention to provide a new and improved incident reporting system that has all of the advantages of the prior art and none of the disadvantages.

It is another object of the present invention to provide an incident reporting system that rapidly notifies vehicle owners when an incident is detected.

Another object of the present invention is to provide around the clock vehicle-monitoring capabilities to automobile owners, thereby enabling owners to check on the status of their vehicle any time.

Yet another object of the present invention is to provide an incident reporting system that provides vehicle owners with near real-time playback of captured data regarding an incident.

Still another object of the present invention is to provide a system for remotely controlling the audio-visual recording devices of a vehicle incident reporting system.

A further object of the present invention is to provide an incident reporting system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a general system schematic of the incident notification and remote control system of the present invention.

FIG. 2 shows a schematic diagram of the modules of the detection and recording subsystem of the present invention with respect to the other components.

FIG. 3 shows a schematic diagram of the modules of the remote server of the present invention with respect to the other components.

FIG. 4 shows a schematic diagram of the modules of the mobile device of the present invention with respect to the other components.

FIG. 5 shows a flow diagram of an exemplary method of detecting an incident and transmitting collected data to the remote server.

FIG. 6 shows a flow diagram of an exemplary method of receiving collected data along with a credential, at the remote server, and forwarding a portion of such information to a mobile device.

FIG. 7 shows a flow diagram of an exemplary method of receiving a notification and information at a mobile device, playing back collected data, and determining whether further action is needed.

FIG. 8 shows a flow diagram of an exemplary method of initiating data collection by the incident reporting subsystem, absent an indication of incident occurrence.

### DETAILED DESCRIPTION OF THE INVENTION

Reference is made herein to the attached drawings. Like reference numerals are used throughout the drawings to depict like or similar elements of the incident reporting system. For the purposes of presenting a brief and clear description of the present invention, the preferred embodiment will be discussed as used for remotely monitoring a vehicle. The figures are intended for representative purposes only and should not be considered to be limiting in any respect.

Systems and techniques described herein are designed to enable a user to remotely monitor his or her vehicle. The vehicle is outfitted with a set of sensory units that trigger operation of several recording devices. Incidents such as collisions, breaking and entering of the vehicle, and detected smoke may trigger multimedia recording by the various recording devices. Captured data is accessible to the owner of the vehicle through an application stored on a client mobile device. Owners can play back the data on demand and can notify authorities via the application if so desired. Data collection may also be triggered by the owner via the application, without detection of an incident. In this manner, the system enables individuals to monitor the status of their vehicle at all times.

Component entities of the present invention include a detecting and recording subsystem, one or more client mobile devices, and a remote server, all in communication over a network such as the Internet. The detection and recording subsystem may include operably connected groupings of impact sensors, motion sensors, door/window breach sensors, and other varieties of intrusion detection or safety sensors; in addition to multimedia recording devices. Client mobile devices include smartphones, table computers, personal digital assistants, laptops and the like. Remote servers are located at sites separate and distinct from the target vehicle and the mobile device. It should be understood that the term remote server is not intended to limit the quantity of servers to a single server. Each of the remote servers restricts communication between the detection and recording subsystem and a client mobile device to only those persons whom the remote server has authenticated. The remote servers also serve as secondary, long-term storage for collected data, and maintain user account information necessary for the operating of the disclosed systems and methods.

Communication between components of the present system is conducted via a network. The term network is used herein to described a global or international network such as the Internet, and it is recognized that smaller networks such as local area networks, wide area networks, and the like may be used to connect individual system components to the global network. The remote server controls communication between components by restricting communication to only authorized users.

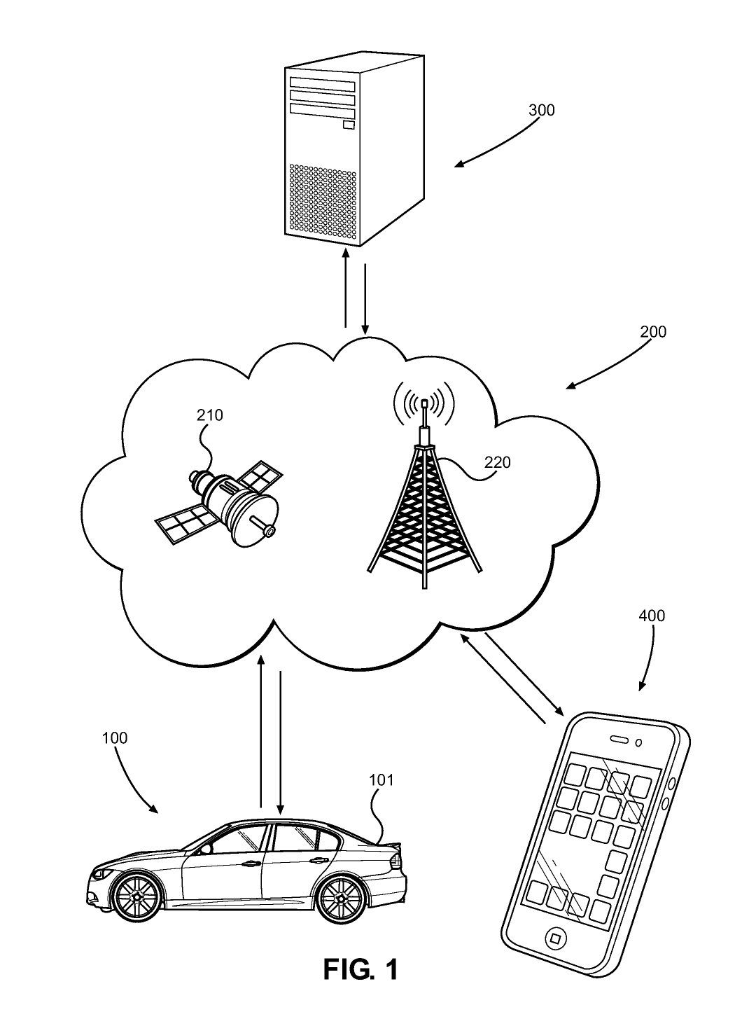

Referring now to FIG. 1, there is shown a diagram of an exemplary configuration of the present system. The detection and recording subsystem 100 is installed within a vehicle 101. Data communications are transmitted and received by the subsystem via a wireless connection to a network 200, and may be enabled by one or more communication relay satellites 210. In most embodiments, data is transmitted to and received from the remote server 300 rather than the client mobile device 400. Because client devices are preferably mobile computing devices, cellular networks 220, may be used to transmit data from the remote server to individual client mobile devices. While it is contemplated that a cellular module such as a GPRS module may be integrated into the detection and recording system to enable direct communication with client mobile devices, these configurations are not preferred because they shift the burden of authentication to the client mobile device 400 and they do not provide a scalable repository for collected data.

The remote sever 300 includes processors, a memory, a storage device (internal or external), input and output ports (I/O), a network connection and other components known to one of ordinary skill in the art of client-server services. Communications between the remote server and the detection and recording subsystem 100 and the client mobile device 400 are transmitted and received over a network. A key function of the remote server is to synchronize transmissions from the subsystem and requests from the client mobile device with a specific user account. Authenticating and synchronizing communications reduces the likelihood that unauthorized persons will gain access to the vehicle's monitoring system, and consequently the vehicle, by forging their credentials.

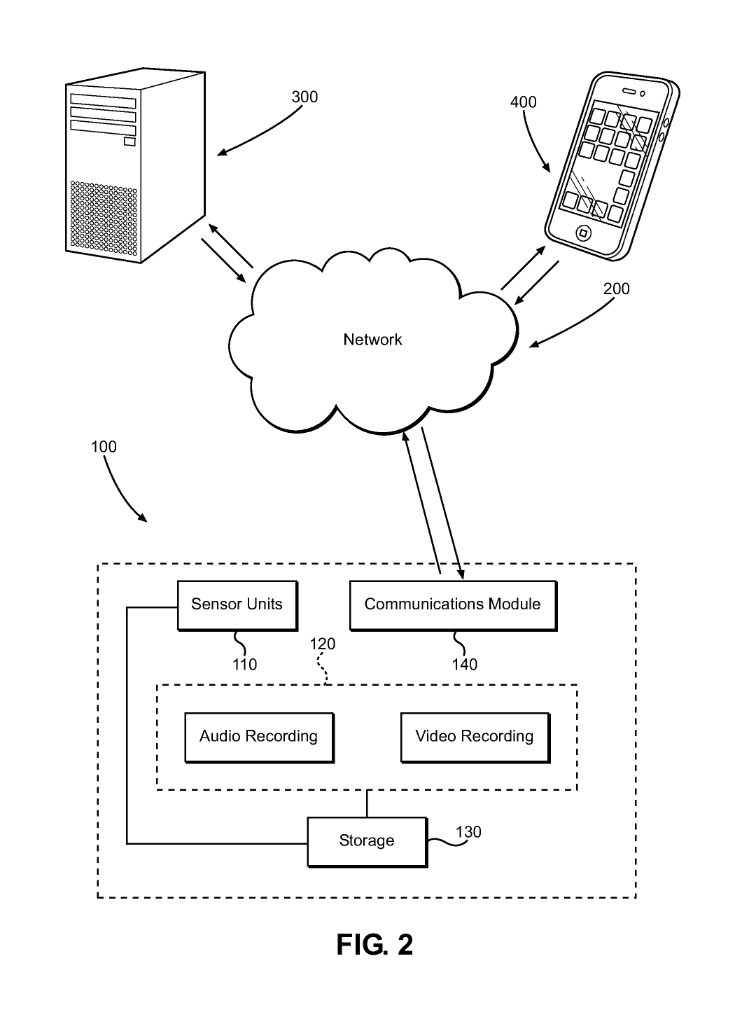

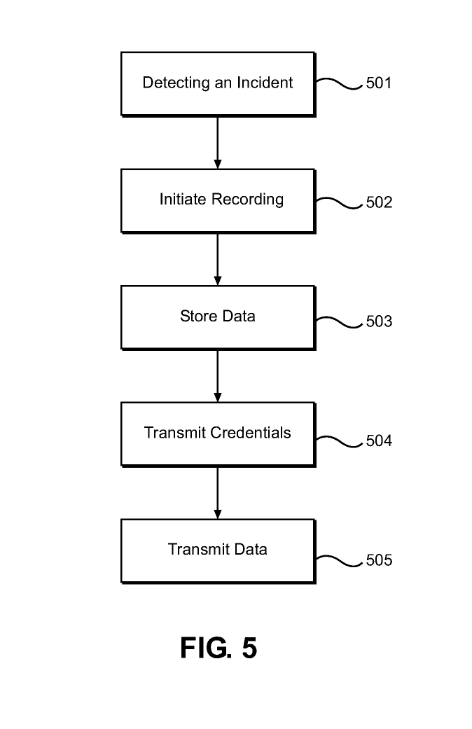

As shown in FIGS. 2 and 5, the detection and recording subsystem 100 comprises several elements. A set of sensor units 110 are installed throughout the vehicle to detect a variety of different threats 501. Motion detectors, window/door breach detectors, smoke detectors, impact detectors, and the like may be installed in any configuration. Precise detection mechanisms offered will depend on the needs of the consumer and the structural nuances of the target vehicle. Positive detection by any of the installed sensor units causes the affected unit to send a signal to a subsystem processor, which in turn sends an activation signal to the recording units 120, 502.

Recording devices 120 will vary according to the implementation of detection units. But several forms of media should be captured using the recording units in order to provide owners and authorities with substantial information about an incident. Video cameras, microphones, temperature gauges with recording capabilities, and the like may be employed to gather as much data as possible about incidents. Placement and installation of the recording devices will vary during installation according to the structure of the vehicle. It will be understood by one of ordinary skill in the art that video cameras and microphones should be disposed throughout the vehicle in such a configuration so as to have coverage of most or all the environment proximate to the vehicle. As data is captured it is stored on storage 130, where the data is maintained in files 503.

Communications transmission may begin at either the positive perception by a sensory unit, i.e. concurrent to initiation of recording, or alternatively may occur at a pre-determined time after recording begins. Delaying communication by a small period of time enables buffering of data being transmitted. The communications module 140 manages transmission of data via a transceiver. Whenever data is sent to the remote server, a credential such as a digital certificate, encrypted vehicle identifier, or the like is also transmitted 504 before or along with transmission of the data 505, in order to authenticate the detection and recording system with the remote server and enable user account lookup. The module further enables receipt of control signals from the remote server 300. Unsolicited transmissions of data to the remote server are initiated when incidents are detected, while requested data acquisitions are transmitted to the remote server upon receipt of a control signal, prompted by client mobile device 400 request for monitoring data. The detection and recording system is thus autonomous and optionally controlled by a remote user.

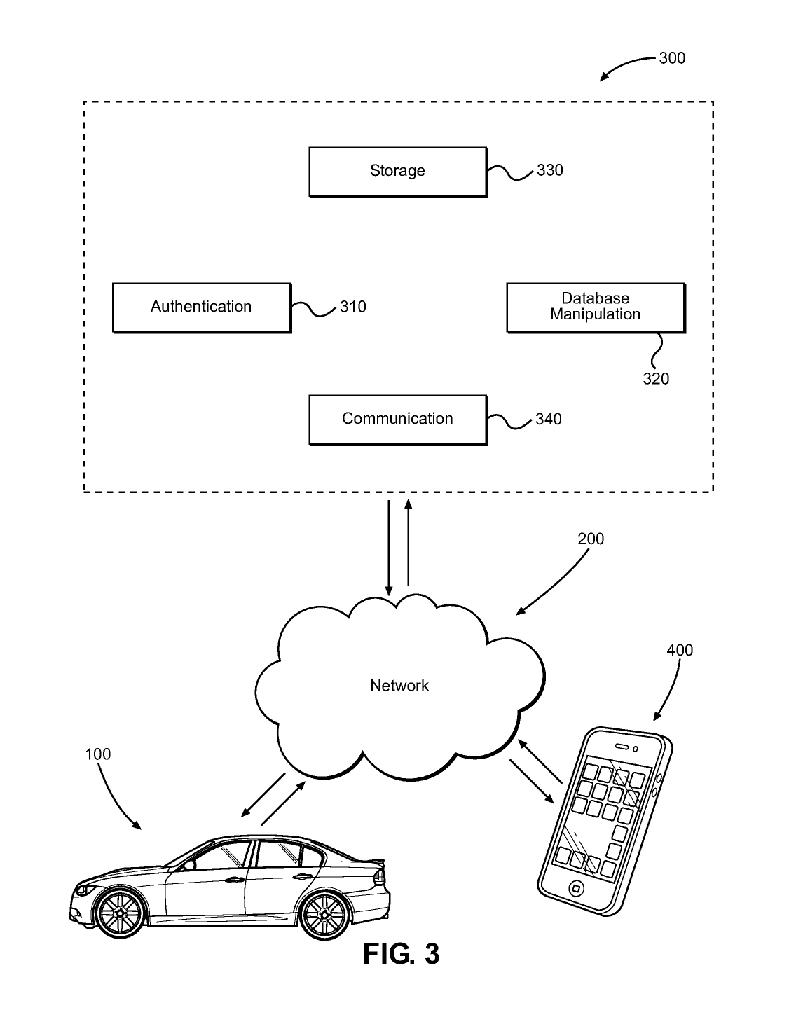

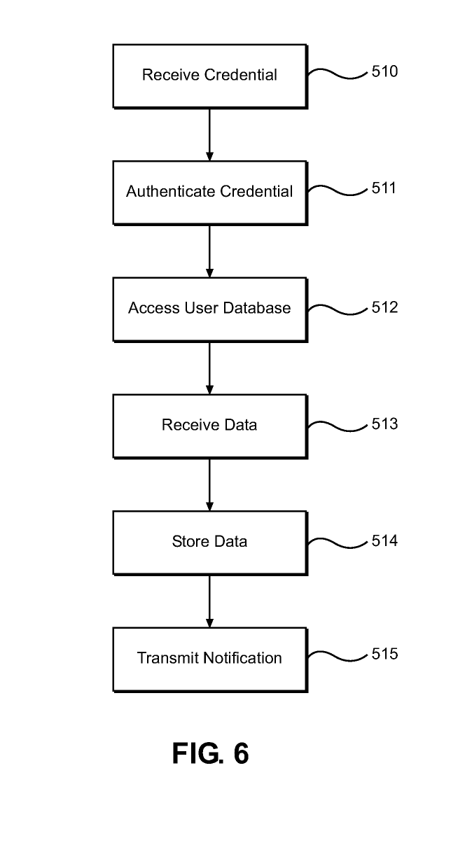

Turning now to FIGS. 3 and 6 the modules of the remote server 300 are shown in some detail. The remote server's communications module 340 receives incoming transmissions from both the detection and recording subsystem 100 and the client mobile device 400. The first part of any transmission received is an authentication credential 510, which may contain a vehicle identifier or a user account identifier depending on whether the transmission originates with the subsystem or the client mobile device. Credentials are sent to the authentication module 310, which decrypts or decodes the credential, and extracts identifiers 511. A database module then uses the identifiers to query a user account database 512. User account information, mobile device contact information, vehicle identifiers, passwords, and the like are stored within the user account database and are not directly accessible via the client mobile device or the detection and recording subsystem. Data received by the communications module 513 is stored 514 on storage 330 once transmission authentication is complete. The user account database will also be updated to include incident information such as timestamp, type of incident, vehicle location, and the like.

In addition to storing data from authenticated sources, the remote server 300 also transmits alert notifications 515 to the client mobile device 400. Database module 320 retrieves the client mobile device contact information at the time of authentication, and upon successful confirmation of identity, sends the contact information to the communications module. Contact information may include an IP address, email, fax number, phone number, or any other information sufficient to direct a transmission to a specific recipient device. The type of contact information will dictate the alert notification technique provided. Notifications may include SMS messages, emails, phone calls, video chat messages, faxes, and so forth, as appropriate for the client mobile device.

In some embodiments, the alert notification will comprise a message and a token. The token is generated by the authentication module 310 as evidence that the data source (the vehicle) is confirmed as associated with the account of the client mobile device user. This step is optional, but recommended as it increases system security, by giving client mobile devices the ability to ignore or deny alert notifications from sources without tokens. Thus, the use of a token may prevent malicious persons from pretending to be the remote server in order to obtain information from the client mobile device.

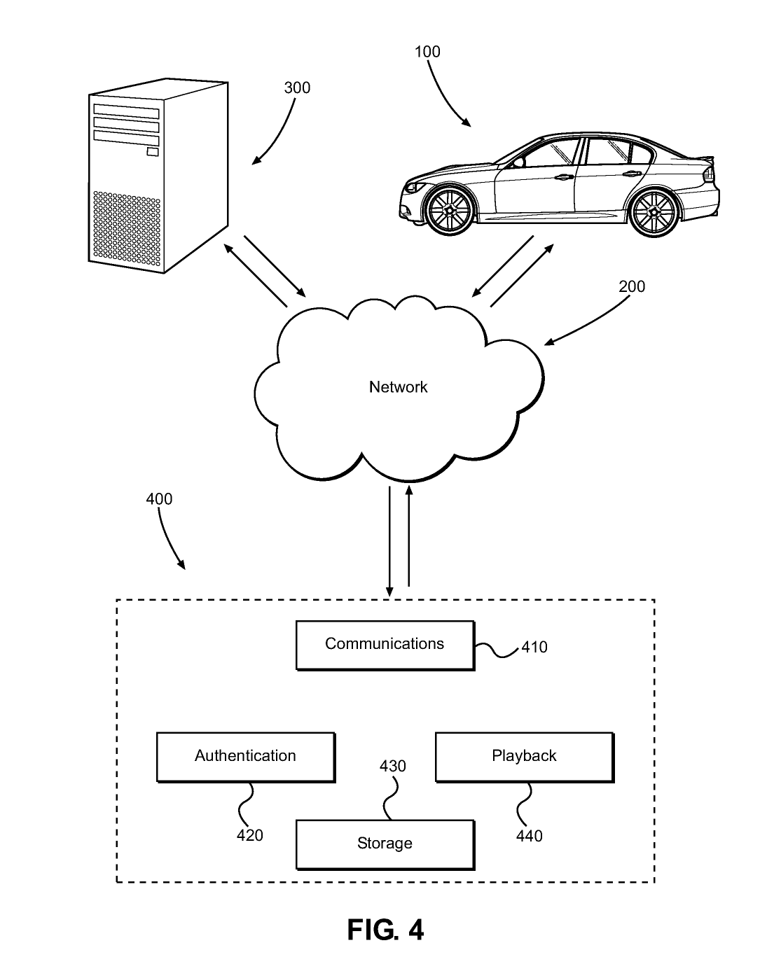

As shown in FIG. 4, the client mobile device 400 has a few necessary modules. The present system tolerates great variety amongst client mobile devices and therefore only the necessary components of the device are discussed in detail herein. Each client mobile device has a communications module 410 that manages incoming transmissions and outgoing requests. In this manner, the client mobile device is connected, via a network 200 to both the remote server 300 and the detection and recording subsystem 100.

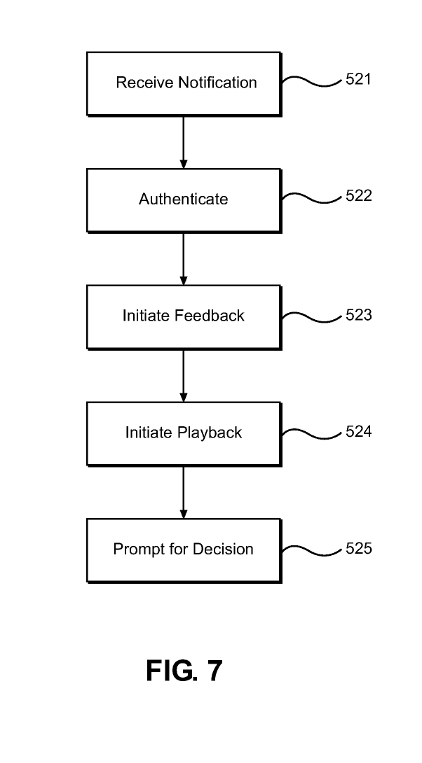

Referring to FIGS. 4 and 7, communications module 410 receives alert notifications 521 and associated tokens from the remote server 300. The token is sent to the authentication module 420, which then checks the token, comparing it against stored credentials 522. If the token is determined to have come from the remote server, the alert notification is passed to the playback module 440. This module initiates tactile, auditory, and visual feedback 523 and directed by a user in their account settings portion of the application. Feedback patterns may be similar to that experienced during text messages and phone calls, or may be different to indicate that a special situation needs user attention.

Some embodiments of the invention may substitute the token for the digital certificate of the detection and recording system. Thus, the remote server merely authenticates the digital certificate and checks it against the user account database, then passes it along to the client mobile device. The client mobile device, in turn compares the digital certificate to it's own user account information to determine if the certificate is legitimate. A third party certificate authority such as the manufacturer or installer of the detection and recording subsystem may issue certificates. In such an embodiment, the user would need to contact the service provider to make changes to their account information, and request a new digital certificate.

Display of alert notifications, is preferably controlled by or associated with the remote control application installed on the client mobile device. By way of example, a text message alert might be displayed to the user along with a link to the application so that the user may open the application to obtain more information about an incident. Alternatively, receipt of an alert from the remote server may initiate startup of the application, and the alert notification displayed within the user interface of the application itself. In each case, the playback module 440 may control the message display.

An application user interface provides users with the ability to review data collected by the detection and recording subsystem 100, and subsequently transferred to the remote server 300. The user selects an option or button displayed within the user interface to view recordings of a recent incident 524. Data associated with the incident is then streamed to the user. Depending upon the length of time lapse associated with data transfer, and the length of time associated with user acknowledgment of the alert notification, the playback may occur in near real-time. Media files of different types may be played back individually, or as a composite. The playback module 440 is responsible for receiving data from the communications module and presenting it to the user via the client mobile device's output elements. Files received from the remote server are stored on a local storage 430 in preparation for playback and may be saved or deleted at the user's discretion.

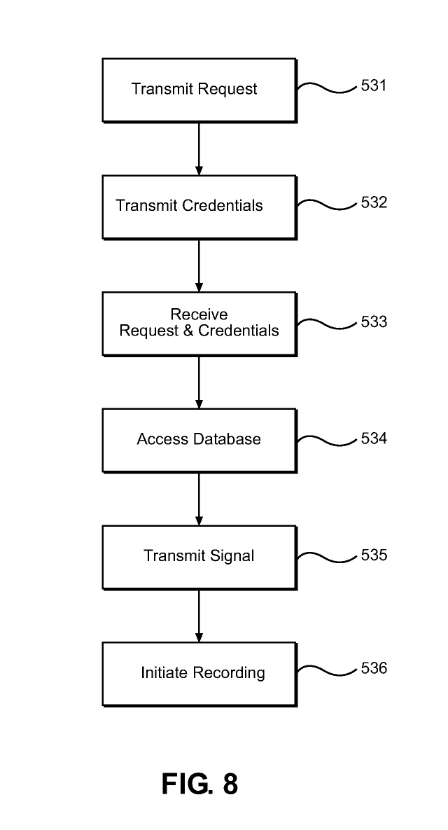

Additionally, the user interface has an option or a button for initiating operation of the detection and recording subsystem. As shown in FIG. 8, engaging this button results in the transmission of a request 531 from the communications module to the remote server. In a preferred embodiment, a stored user account identifier and password are transmitted to the remote server 532 along with the request in order to authenticate the user of the client mobile device.

The remote server receives the credentials and the request 533 and passes them to the authentication module. The authentication module extracts the account identifier and password and accesses the database 534 to verify the information and find contact information associated with the vehicle identifier belonging to the account.

Some user accounts may have multiple vehicle identifiers associated with the account, because people often own multiple vehicles. To prevent confusion, the user interface has a selection menu that enables users to select one or all of the vehicles they wish to monitor. For security purposes, the vehicle identifiers are not stored in the storage of the client mobile device. But each vehicle entered into the application as a user vehicle will be assigned a code such as A1, 1a1, or the custom names. This information will subsequently be pushed to the remote server and linked to vehicle identifiers. When a user submits a request to monitor her 1959 Ferrari Testa Rosa a code reading “59Fer” may be sent in conjunction with the account identifier and password. If the remote server database is unable to find a match, an error may be returned to the user, prompting them to call customer service.

Upon confirmation of the credentials and obtaining of the vehicle contact information, the remote server transmits an initiation control signal to the vehicle 535. The communications module of the target detection and recording subsystem receives the control signal and initiates recording 536. Data is thus collected and transmitted back to the remote server and client mobile device in the same manner as though an incident was detected. In some embodiments, the sending of the alert notification may be skipped when a user is requesting the data collection. It is noted, that the user should also be provided a terminate recording option so that she may turn the detecting and recording subsystem operation off if all is well with the vehicle. Various detection and recording system settings may be toggled within the setting portion of the application user interface. By way of illustration, recording timers may be set, and some detectors may be turned on or off, to reduce the frequency of false alarms.

In some embodiments the application provides a user with options for following up on an incident, such as at step 525 of FIG. 7. A first option or button is displayed for “ignore alert”, for when the user reviews data playback and determines that a “false alarm” occurred. This may happen when a person or animal walks too close to the vehicle, or a small impact occurs, such as a beach ball bouncing off the hood. Storage of data associated with such incidents would be wasteful and unnecessary. It is therefore advantageous that the user be able to delete data from the client mobile device and instruct the remote server to do likewise.

A second option is displayed to the user for “call police.” This option opens a call window within the interface, or instructs a message to be sent to local authorities from the remote server. In some embodiments, the detection and recording subsystem includes a global positioning system (GPS) unit that determines the location of the vehicle and relays this information to the remote server upon request, thereby enabling the remote server to determine the contact information of a police department proximal to the vehicle, and send an alert to same. Alerts to police may be digital messages or may be recorded phone calls. Data collected with regard to an incident is also transmitted to the police for evidentiary purposes.

In other embodiments, users may have to call the police department themselves and the “police” button on the user interface is used to transmit data to a department, once notified. In any embodiment the system facilitates evidence retention and immediate notification of authorities that an incident has occurred involving the monitored vehicle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An incident reporting system for a vehicle, comprising:
one or more remote servers, having a communications module adapted to send and receive data, server storage, a user account database, and an authentication module;
one or more client mobile devices having a communications module, client storage, and a stored application, wherein said stored application includes an authentication module and a playback module;
a detection and recording subsystem installed in a vehicle and comprising a plurality of sensory units, a plurality of recording devices, a transceiver, a processing unit, and a vehicle storage;
a network, wherein each of said one or more remote servers, one or more client mobile devices, and detection and recording subsystem is configured to communicate over said network.

2. The system of claim 1, wherein said sensory units comprise one or more of an impact sensor, a motion detector, an entry breach sensor, or a fire detector.

3. The system of claim 1, wherein activation of said sensory units results in initiation of recording by said recording devices.

4. The device of claim 1, wherein data recorded by said recording devices is stored on said vehicle storage and transmitted via said transceiver.

5. The system of claim 1, wherein said one or more remote servers are operable to receive communications from said detection and recording system, or said one or more client mobile devices, wherein said communications include a set of credentials.

6. The system of claim 5, wherein said set of credentials includes a unique vehicle identifier and a user account identifier when communicated from said detection and recording system.

7. The system of claim 5, wherein said set of credentials includes a password and a user account identifier.

8. The system of claim 1, wherein said server storage is configured to retain data received from said detection and recording subsystem, and to update said user account database with information regarding data received from said detection and recording subsystem.

9. The system of claim 1, wherein said one or more remote servers are configured to transmit an alert notification to said one or more client mobile devices upon receipt of data from said detection and recording subsystem.

10. The system of claim 1, wherein said one or more client mobile devices stored application is configured to receive data from said one or more remote servers regarding an incident perceived by said detection and recording subsystem.

11. The system of claim 10, wherein said stored application is configured to enable playback of data transmitted from said one or more remote servers subsequent to transmission from said detection and recording subsystem.

12. The system of claim 1, wherein said stored application is configured to transmit a request to said one or more remote servers, and said one or more remote servers in turn are configured to transmit an initiation control signal to a target detection and recording subsystem in response to receipt of said request.

13. The system of claim 1, wherein data collected by said detection and recording subsystem is transmitted by one of said detection and recording subsystem, said one or more client mobile devices, or said one or more remote servers to emergency responder authorities.

14. A method of remotely viewing data collected by a vehicle monitoring system, comprising:
detecting an incident at a vehicle, by a detection and recording system installed on said vehicle;
initiating recording via a plurality of recording devices of an environment proximal to said vehicle;
storing data recorded by said plurality of recording devices on a local storage;
transmitting said data to one or more remote servers;
receiving and storing said data at said local storage on said one or more remote servers;
updating an entry linked to said vehicle in a user account database with said data;
transmitting an alert notification to one or more client mobile devices;
receiving and displaying said alert notification at said one or more client mobile devices;
prompting a user to review playback of said data;
playing said data back via output elements of said one or more client mobile devices.

15. A method of initiating recording of an environment surrounding a vehicle from a remote device comprising:
initiating a request for recording from an application stored on a client mobile device;
transmitting said request to one or more remote servers;
receiving said request at said one or more remote servers;
accessing a user account database for vehicle contact information associated with an account linked to said client mobile device;
transmitting an initiation control signal to a detection and recording system associated with said vehicle contact information;
initiating recording by a plurality of recording devices of an environment proximal to said vehicle.

16. The method of claim 15, further comprising the steps of:
transmitting data recorded by said plurality of recording devices to said one or more remote servers;
receiving and storing said data on a local storage at said one or more remote servers;
transmitting said data to said client mobile device;
receiving and playing back said data on said client mobile device via said stored application.

17. The method of claim 16 wherein said data transmitted from said one or more remote servers to said client mobile device is transmitted via streaming.
